(19) United States
(12) Patent Application Publication
(10) Pub. No.: US 2011/0084417 A1
(43) Pub. Date: Apr. 14, 2011

(54) LARGE AREA LINEAR ARRAY NANOIMPRINTING

(75) Inventors: Byung-Jin Choi, Austin, TX (US); Sidlgata V. Sreenivasan, Austin, TX (US); Anshuman Cherala, Austin, TX (US)

(73) Assignee: MOLECULAR IMPRINTS, INC., Austin, TX (US)

(21) Appl. No.: 12/900,071

(22) Filed: Oct. 7, 2010

Related U.S. Application Data
(60) Provisional application No. 61/249,845, filed on Oct. 8, 2009.

(51) Int. Cl. B29C 59/02

(52) U.S. Cl. 264/40.5

(57) ABSTRACT

Systems and methods for imprinting and aligning an imprint lithography template with a field on a substrate are described. The field of the substrate may include an elongated side, and alignment sensitivity on the elongated side may be intentionally minimized.

### CROSS REFERENCE TO RELATED APPLICATIONS

The present application claims priority to U.S. Provisional Application No. 61/249,845 filed Oct. 8, 2009, which is hereby incorporated by reference.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are herein incorporated by reference.

An imprint lithography technique disclosed in each of the aforementioned U.S. patent publications and patent includes formation of a relief pattern in a polymeric layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is substantially solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF THE DRAWINGS

So that features and advantages may be understood in detail, a more particular description of embodiments may be had by reference to the embodiments illustrated in the drawings. It is to be noted, however, that the drawings only illustrate typical embodiments, and are therefore not to be considered limiting of its scope.

FIG. 1 is a simplified side view of a lithographic system.

FIG. 2 illustrates a simplified top down view of a field of a substrate.

FIG. 3 illustrates a simplified top down view of a linear array field of a substrate in accordance with embodiments of the present invention.

FIG. 4A illustrates a block diagram of an exemplary linear array template.

FIG. 4B illustrates a block diagram of another exemplary linear array template.

FIG. 5A illustrates a view of the exemplary linear array template along cross section AA′ of FIG. 4A.

FIG. 5B illustrates a view of the exemplary linear array template along cross section BB′ of FIG. 4B.

FIG. 6A illustrates a simplified top down view of an exemplary fluid dispense system for depositing formable material for patterning with a linear array template.

FIG. 6B illustrates a simplified top down view of another exemplary fluid dispense system for depositing formable material for patterning with a linear array template.

FIG. 7 illustrates a block diagram of an exemplary energy system providing energy to a linear array field of substrate.

FIG. 8A illustrates a simplified side view of a linear array template and a substrate during an exemplary imprinting process.

FIG. 8B illustrates a diagrammatic view of a linear array template during the exemplary imprinting process of FIG. 8A.

FIG. 8C illustrates a diagrammatic view of a substrate during the exemplary imprinting process of FIG. 8A.

FIG. 9A illustrates a simplified side view of a linear array template and a substrate during another exemplary imprinting process.

FIG. 9B illustrates a diagrammatic view of a substrate during the exemplary imprinting process of FIG. 9A.

FIG. 10 illustrates a simplified side view of a substrate having a patterned layer formed thereon.

FIG. 11 illustrates a simplified side view of a linear array template and a substrate during an exemplary separation process.

FIG. 12A illustrates a perspective view of an exemplary alignment system for use with a linear array template.

FIG. 12B illustrates a diagrammatic view of the exemplary alignment system of FIG. 12A.

FIG. 13 illustrates a diagrammatic view of another exemplary alignment system.

FIG. 14 illustrates a diagrammatic view of an exemplary magnification and distortion compensation system for use with a linear array template.

FIG. 15 illustrates a diagrammatic view of an exemplary magnification and distortion compensation system for use with a linear array template having a plurality of mesas.

### DETAILED DESCRIPTION

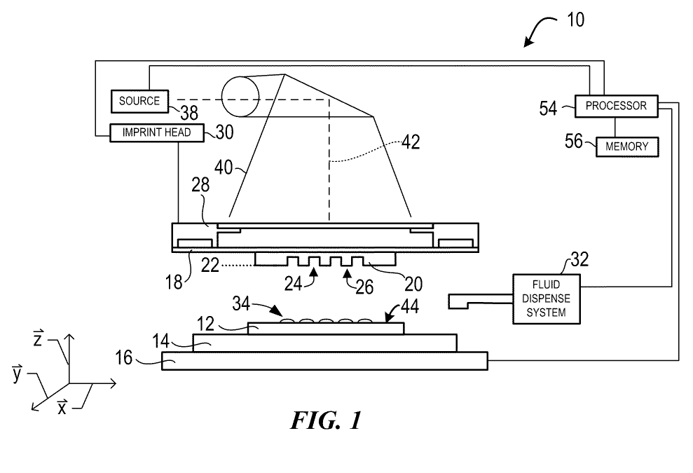

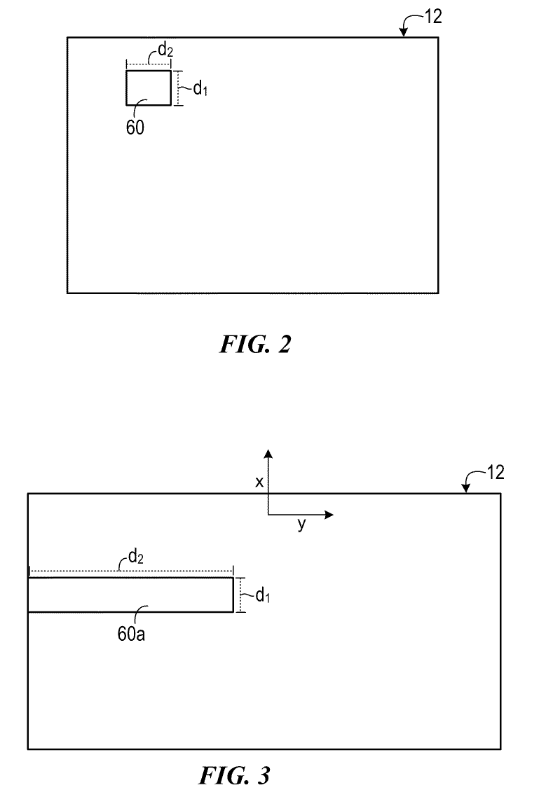

Referring to the Figures, and particularly to FIGS. 1 and 2, illustrated therein is a lithographic system 10 used to form a relief pattern on substrate 12. Imprint lithography techniques generally employ nanomolding techniques to replicate patterns onto substrate 12. In the step and repeat imprint lithography processes, an array of drops of polymerizable material 34 may be dispensed in a drop pattern onto substrate 12 and field 60 of substrate imprinted using patterns provided by template 18.

Field 60 of substrate 12 may be imprinted using template 18 and this process repeated for each individual field 60 on substrate 12. Such techniques are further described in U.S. Pat. No. 6,334,960, which is hereby incorporated by reference in its entirety. Standardized sizes for field 60 are used to conform to commercial manufacturing to guidelines within already established photolithography. For example, sizes of field 60 may be 26*33 mm or 26*32 mm. This small size for each field 60 provides quality overlay. Overlay performance, however, tends to decrease with an increase in size of field 60.

Alternatively, the entire substrate 12 may be imprinted using whole wafer techniques. For example, such techniques are further described in U.S. Patent Publication No. 2005/0189676, which is hereby incorporated by reference in its entirety.

Referring to FIGS. 1-2, increasing size of field 60 for a step and repeat imprint lithography process is expected to cause overlay issues. As such, size of field 60 has generally remained conformed to standardized sizes within the industry. Referring to FIGS. 3-5, design of a linear array template 18a having an elongated dimension as described herein, as well as techniques and systems used in imprinting, may be used to pattern substrate 12 providing an array field 60a having dimensions greater than the standard sizes seen within the industry. To provide overlay performance sensitivity suitable for an imprint lithography process, high accuracy overlay performance may be limited in one-direction and/or dimension of template 18a (e.g., sensitivity in x-direction, non-sensitivity in y-direction), and as such, template 18a may be used to pattern array field 60a of substrate 12.

Array field 60a (shown in FIG. 3) may be larger than the standardized field 60 (shown in FIG. 2) currently used within an industry. For example, single field 60 may include dimensions d₁ and d₂ (e.g., dimensions of 26- by 33-mm or 26- by 32-mm in the semiconductor industry, 12 mm by 48 mm in the patterned media industry). Array field 60a may be a multiple n of standard field size dimensions d₁ providing dimensions (n* d₁) and d₂ or d₁ and (n*d₂). Alternatively, array field 60a may include dimensions d₁ and d₂ unrelated to dimensions of standardized field 60 within industry, however, at least one dimension (e.g., d₁) of array field 60a is at least twice the magnitude of the remaining dimension (e.g., d₂). For example, in the semiconductor industry, for a 300 mm substrate 12, array field 60a may be approximately 26 by 150 mm. As such, array field 60a includes at least one long dimension (e.g., d₂) and at least one short dimension (d₁).

Overlay in one dimension d₁ (e.g., shorter dimension of array field 60a) may be controlled similar to practices known within the industry to control overlay in field 60 and methods disclosed herein, while overlay performance of dimension d₂ (e.g., longer or elongated dimension of array field 60a) is intentionally minimally controlled or intentionally not controlled (e.g., alignment sensitivity is intentionally minimized). Although contrary to accepted practice in the industry, by patterning array field 60a and controlling only one dimension for high accuracy overlay performance, throughput of the patterning process may increase and costs related to masks 20 and/or template 18a use and/or formation may decrease.

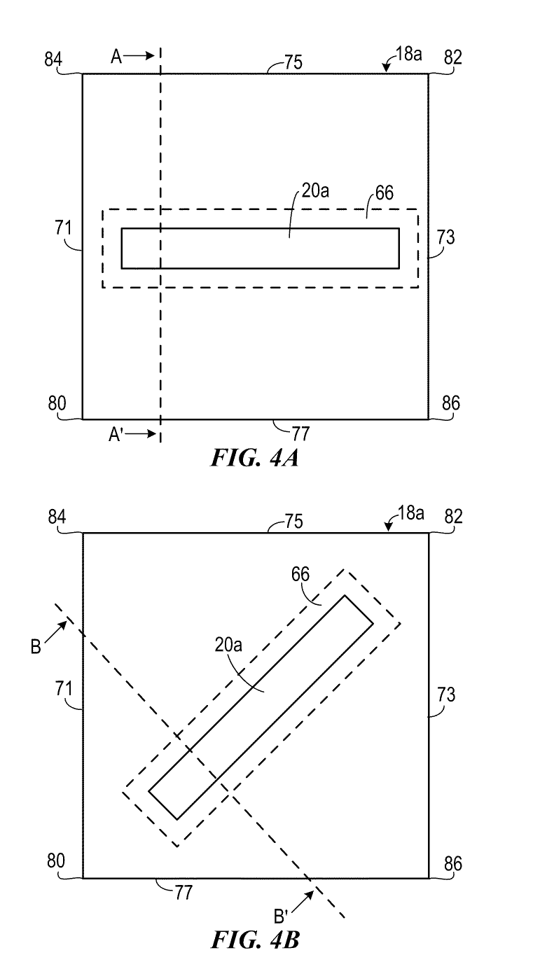

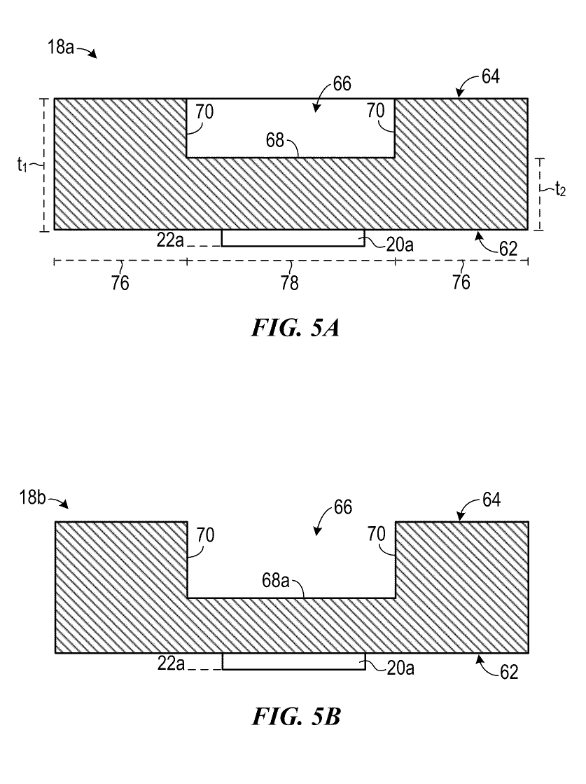

FIGS. 4-5 illustrate exemplary templates 18a and 18b. Template 18a may include a first side 62 and a second side 64. First side 62 may include a mesa 20a having a patterning surface 22a thereon. Further, mesa 20a may be referred to as mold 20a. Template 18a and/or mold 20a may be formed from such materials including, but not limited to, fused-silica, quartz, silicon, organic polymers, siloxane polymers, borosilicate glass, fluorocarbon polymers, metal, hardened sapphire, and/or the like.

Second side 64 of template 18a may include a recess 66 disposed therein. Recess 66 may be formed by a first surface 68 and recess wall 70. In one embodiment, as illustrated in FIG. 5B, first surface 68a may extend the length of template 18a. Recess wall 70 may extend transversely between first surface 68 and a second surface 74. Recess 66 may be in superimposition with mesa 20a. Shape of recess 66 may be circular, triangular, hexagonal, rectangular, or any fanciful shape.

Template 18a may include a first region 76 and a second region 78. First region 76 may surround second region 78. Second region 78 may be in superimposition with recess 66. As such, template 18 may have a first thickness t₁ associated with first region 76 and a second thickness t₂ associated with second region 78 wherein first thickness t₁ is greater than second thickness t₂.

First side 62 may include mold 20a having patterning surface 22a. Patterning surface 22a includes features defined by a plurality of spaced-apart recesses 24 and/or protrusions 26 (shown in FIG. 1). Patterning surface 22 may define any original pattern that forms the basis of a pattern to be formed on substrate 12. In one example, template 18a may conform to industry standard size of 0.25-in thick 6 in by 6 in.

Mold 20a may include a first side having a first dimension (i.e. length) and a second side having a second dimension (i.e., width). Mold 20a may be elongated in one dimension (e.g., length) such that mold 20a (i.e., array mold 20a) extends from a first side 71 of template 18a to a second side 73 of template 18a forming a linear array. In another example, mold 20a (i.e., array mold 20a) may be elongated in one dimension extending from a third side 75 of template 18a to a fourth side 77 of template 18a. Mold 20a may be substantially centered about sides 71 and 73 or 75 and 77. Alternatively, mold 20a may be positioned at any point about sides 71 and 73 or 75 and 77. Additionally, mold 20a may be angled. For example, mold 20a may be angled such that mold 20a extends from a first corner edge 80 of template 18a to a second corner edge 82 of template 18a. In another example, mold 20a may be positioned at an angle on template 18a such that mold 20a extend from a third corner edge 84 to a fourth corner edge 86.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. Template 18a may other additional design characteristics such as those described in further detail in U.S. Patent Publication No. 2008/0160129, which is hereby incorporated by reference in its entirety.

Substrate 12 may be any substrate used in the semiconductor industry, patterned media industry, biomedical industry, solar cell industry, and the like. For example, substrate 12 may be a 65 mm or 95 mm disk used in the patterned media industry. In another example, substrate 12 may be a 300 mm or 450 mm wafer.

Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is herein incorporated by reference.

Substrate 12 and substrate chuck 14 may be further supported by stage 16. Stage 16 may provide motion along the x-, y-, and z-axes. Stage 16, substrate 12, and substrate chuck 14 may also be positioned on a base (not shown).

Template 18 may be coupled to chuck 28. Chuck 28 may be configured as, but not limited to, vacuum, pin-type, groove-type, electromagnetic, and/or other similar chuck types. Such chucks are further described in U.S. Pat. No. 6,873,087, U.S. Pat. No. 6,982,783, U.S. Ser. No. 11/565,393, and U.S. Ser. No. 11/687,902, which are all herein incorporated by reference in their entirety. Further, chuck 28 may be coupled to imprint head 30 such that chuck 28 and/or imprint head 30 may be configured to facilitate movement of template 18.

System 10 may further include a fluid dispense system 32. Fluid dispense system 32 may be used to deposit materials on substrate 12. For example, fluid dispense system 32 may be used to deposit a formable liquid material 34 on substrate 12. Material 34 may be positioned upon substrate 12 using techniques such as drop dispense, spin-coating, dip coating, chemical vapor deposition (CVD), physical vapor deposition (PVD), thin film deposition, thick film deposition, and/or the like. Material 34 may be disposed upon substrate 12 before and/or after a desired volume is defined between mold 22 and substrate 12 depending on design considerations. Material 34 may include a monomer mixture as described in U.S. Pat. No. 7,157,036 and U.S. Patent Publication No. 2005/0187339, both of which are herein incorporated by reference. Additionally, it should be noted that materials may include functional materials in the patterned media industry, semiconductor industry, biomedical industry, solar cell industry, opticalelectric industry, and the like.

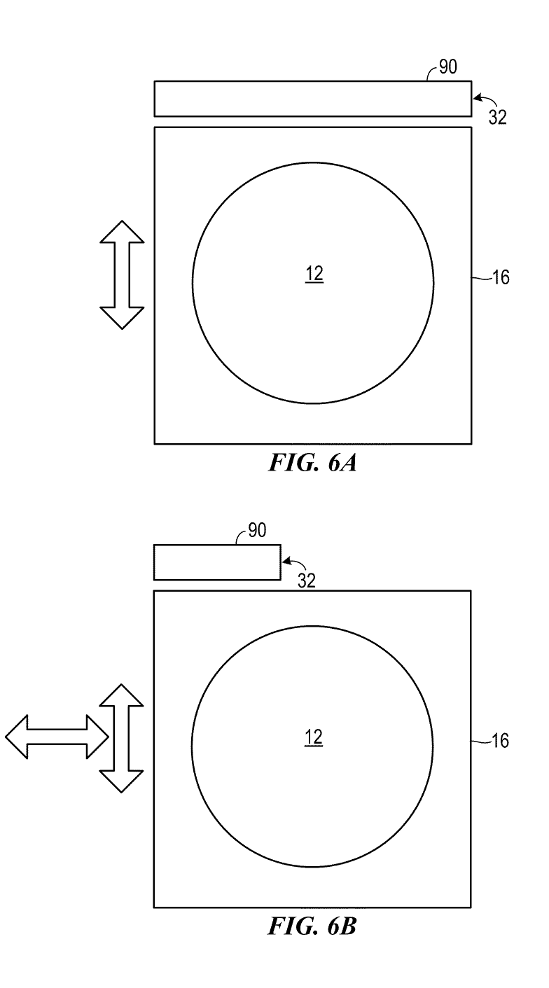

Referring to FIGS. 6A and 6B, fluid dispense system 32 may include a dispense head 90. Dispense head 90 may provide deposition of formable liquid material 34 on substrate 12. Dispense head 90 may extend substantially the length of substrate 12 as illustrated in FIG. 6A or dispense head 90 may extend a portion of the length of substrate 12. Extension of the dispense head 90 the length of substrate 12 may limit movement of stage 16 for deposition of formable material 34 on substrate. For example, stage 16 may position substrate 12 in superimposition with dispense head 90 such that formable material 34 may be deposited on substrate 12. If dispense head 90 extend substantially the length of substrate 12, stage 16 may move in a first direction (e.g., y-direction) to position substrate 12 in superimposition with dispense head 90 and have only limited adjusting movements in a second direction (e.g., x-direction). If dispense head 90 extends only a portion of the length of substrate 12, as illustrated in FIG. 6B, stage 16 may move in the first direction and the second direction (e.g., both x and y-directions) to position substrate 12 in superimposition with dispense head 90.

Referring to FIG. 1, system 10 may further include an energy source 38 coupled to direct energy 40 along path 42. Source 38 produces energy 40, e.g. broadband ultraviolet radiation, causing material 34 to solidify and/or cross-link. In one embodiment, source 38 may be an LED light source.

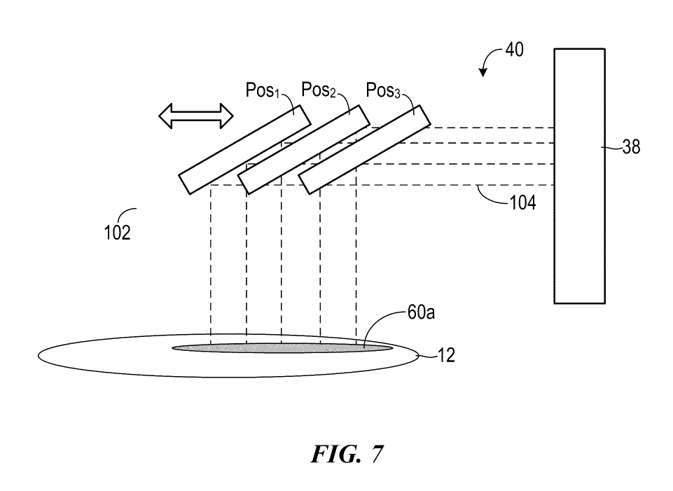

In one example, as illustrated in FIG. 7, source 38 may be a scanning light source 100. Scanning light source 100 may include a reflective element 102. For example, reflective element 102 may be a mirror adjustably positioned at an angle. Reflective element 102 may provide motion along the x-, y-, and z-axes. For example, reflective element 102 may be slidably positioned at Pos₁, Pos₂, and Pos₃ such energy 40 may be provided across length of at least field 60a of substrate 12. Energy 40 may be provided by source 38 to reflective element 102 in a beam 104 and/or reflective element 102 may receive energy 40 from source 38 and provide energy 40 to substrate 12 in shape of the beam 104. In one example, beam shape 104 may be substantially similar to the shape of array field 60a.

Imprint head 30 and stage 16 may be configured to position template 18 and substrate 12 in superimposition with beam 104. System 10 may be regulated by a processor 54 in communication with stage 16, imprint head 30, fluid dispense system 32, and/or source 38 and may operate on a computer readable program stored in memory 56.

Referring to FIG. 1, either imprint head 30, stage 16, or both vary a distance between mold 20 and substrate 12 to define a desired volume therebetween that is filled by material 34. For example, imprint head 30 may apply a force to template 18 such that mold 20 contacts material 34.

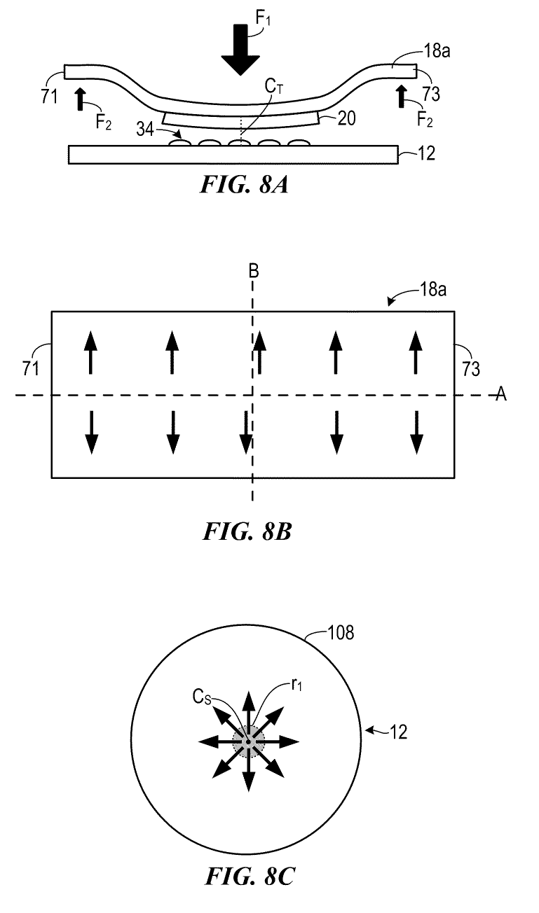

In one embodiment, as illustrated in FIG. 8A, shape of template 18a may be altered such that desired volume may be filled by material 34. For example, force F₁ and/or F₂ may be applied to template 18a such that sides 71 and 73 and/or sides 75 and 77 bow away from the substrate 12 and axis A, axis B, and/or center C_{T} of the template 18a bows towards substrate 12. Force F₁ and/or F₂ applied to template 18a may be direct force or applied force from a system (e.g., pump system). Force F₁ and/or F₂ may be applied during initial contact of template 18a to formable material 34 and then reduced to promote spreading of formable material 34 between template 18a and substrate 12.

Referring to FIGS. 8A-8C, in one example, force F₁ and/or F₂ may be applied to template 18a to bow edges 75 and 77 away from substrate 12 and bow a region that includes axis A toward substrate 12 such that formable material 34 along axis A of template 18a spreads towards edges 75 and 77. In another example, force F₁ and/or F₂ may be applied to template 18a to bow edges 71 and 73 away from substrate 12 and bow a region that includes axis B toward substrate 12 such that formable material 34 along axis B of template 18a spreads towards edges 71 and 73. Alternatively, force F₁ and/or F₂ may be applied to template 18a such that edges 71, 73, 75 and 77 bow away from substrate 12 and center C_{T} of template 18a bows towards substrate 12. In this example, formable material 34 surrounding middle radius r₁ of substrate 12 may spread towards edge 108 of substrate 12 as illustrated in FIG. 8C.

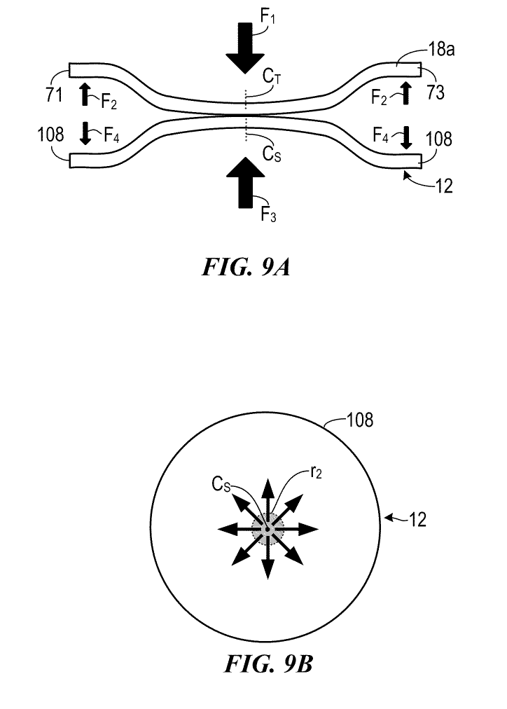

Referring to FIGS. 9A and 9B, shape of substrate 12 may be altered in addition to or in lieu of shape alteration of template 18a. For example, force F₃ and/or F₄ may be applied to substrate 12 such that edge 108 of substrate 12 bows away from template 18a and center C_{S} of substrate bows toward template 18a. Force F₃ and/or F₄ applied to substrate 12 may be direct force or applied force from a system (e.g., pump system). For example, force F₃ and/or F₄ may be applied using systems and processes described in U.S. Ser. No. 11/687,902. Formable material 34 surrounding middle radius r₂ of substrate 12 spreads towards edge 108 of substrate 12 as illustrated in FIG. 9B.

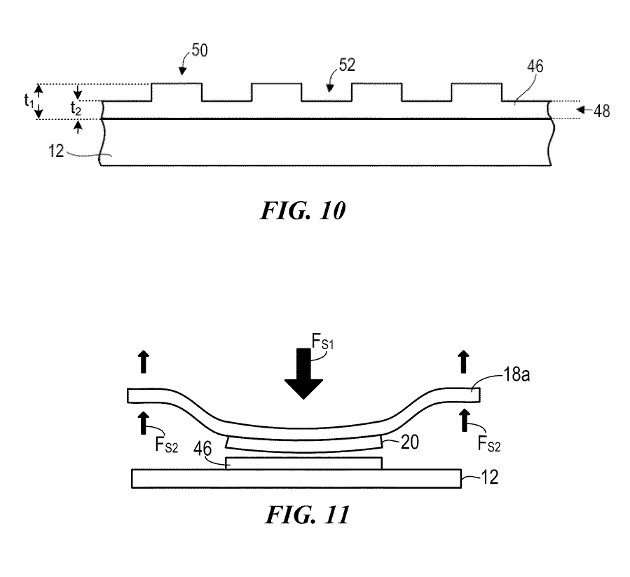

Referring to FIGS. 1 and 10, after the desired volume is filled with material 34, source 38 produces energy 40, e.g. broadband ultraviolet radiation, causing material 34 to solidify and/or cross-link conforming to shape of a surface 44 of substrate 12 and patterning surface 22, defining a patterned layer 46 on substrate 12. Patterned layer 46 may include a residual layer 48 and a plurality of features shown such as protrusions 50 and recessions 52, with protrusions 50 having thickness t_{F} and residual layer having a thickness t_{RL}.

Referring to FIGS. 11A and 11B, after formation of patterned layer 46, template 18a may be separated from patterned layer 46. Separation may include techniques as further described in U.S. Ser. No. 11/687,902, U.S. Ser. No. 11/108,208, U.S. Ser. No. 11/047,428, U.S. Ser. No. 11/047,499, and U.S. Ser. No. 11/292,568, all of which are hereby incorporated by reference in their entirety.

In one embodiment, as illustrated in FIG. 11, shape of template 18a may be altered during separation of template 18a from patterned layer 46. For example, force F_{S1} and/or F_{S2} may be applied to template 18a such a portion of template 76 may bow away from the substrate 12 and center C_{T} of the template 18a may bow towards substrate 12. Force F_{S1} and/or F_{S2} applied to template 18a may be direct force or applied force from a system (e.g., fluid pressure system).

One exemplary separation system and method for use with template 18a is further described in U.S. Ser. No. 11/292,568, which is hereby incorporated by reference in its entirety. Generally, the separation system and method may reduce force F_{S2} applied to template 18a by creating localized separation between mold 20 and patterned layer 46 at a region proximate to a periphery of mold 20. Localized separation may be provided by applying downward force F_{S1} to template 18a. Applying downward force F_{S1} distorts the shape of a region of template 18a causing periphery of mold 20 to separate from substrate 12. It should be noted that shape of substrate 12 may be altered in addition to or in lieu of shape alteration of template 18a.

The above-mentioned system and process may be further employed in imprint lithography processes and systems referred to in U.S. Pat. No. 6,932,934, U.S. Pat. No. 7,077,992, U.S. Pat. No. 7,179,396, and U.S. Pat. Nos. 7,396,475, 7,442,336, all of which are herein incorporated by reference in their entirety.

Not obtaining proper alignment between mold 20a and substrate 12 may introduce errors in patterned layer 46. In addition to standard alignment errors, magnification/run out errors may create distortions in patterned layer 46 due, inter alia, to extenuative variations between mold 20a and substrate 12. The magnification/run-out errors may occur when a region of substrate 12 in which pattern on mold 20a is to be recorded exceeds the area of the pattern on mold 20a. Additionally, magnification/run-out errors may occur when the region of substrate 12 in which pattern of mold 20a is to be recorded has an area smaller than the original pattern.

The deteleterious effects of magnification/run-out errors may be exacerbated when forming multiple patterns in a common region. Additional errors may occur if pattern on mold 20a is rotated, about an axis normal to substrate 12 (i.e., orientation error), with respect to the region of substrate 12 in which the pattern on mold 20a is to be recorded. Additionally, distortion may be caused when the shape of periphery of mold 20a differs from the shape of the perimeter of the region on substrate 12 on which the pattern is to be recorded. This may occur, for example, when transversely extending perimeter segments of mold 20a and/or substrate 12 are not orthogonal (i.e., skew/orthogonality distortions).

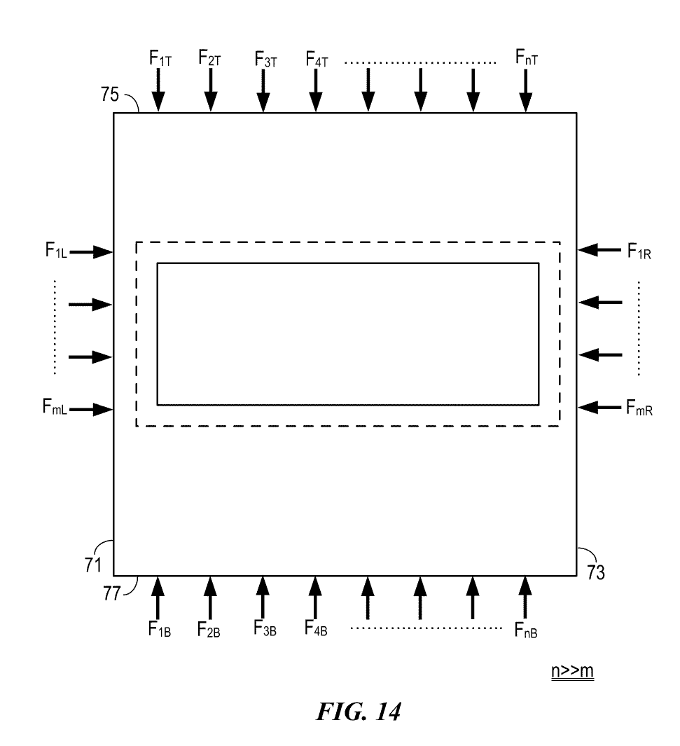

Referring to FIGS. 13-14, to ensure proper alignment between substrate 12 and mold 20a, generally sets of alignment marks 110 positioned on and/or within template 18 and/or substrate 12 may be used with an alignment system 112.

In one embodiment, as illustrated in FIG. 13, alignment system 112 may include an interferometric analysis tool such as the interferometric analysis tool described in further detail in U.S. Ser. No. 11/000,331, which is hereby incorporated by reference in its entirety. The interferometric analysis tool may provide data concerning multiple spatial parameters of both template 18a and substrate 12 and/or provide signals to minimize differences in spatial parameters.

Alignment system 112 may be coupled to sense one or more alignment marks 110 on or within template 18a (i.e., template alignment marks) and/or one or more alignment marks 110 on or with substrate 12 (i.e., substrate alignment marks). Generally, alignment system 112 may determine multiple relative spatial parameters of template 18a and substrate 12 based on information obtained from sensing alignment marks 110. Spatial parameters may include misalignment therebetween, as well as relative size difference between substrate 12 and template 18a, referred to as a relative magnification/run out measurement, and relative non-orthogonality of two adjacent transversely extending edges on either template 18a and/or substrate 12, referred to as a skew measurement. Additionally, alignment system 112 may determine relative rotational orientation about the Z direction, which may be substantially normal to a plane in which template 18a lies and a surface of substrate 12 facing template 18a.

As design of linear array template 18a includes an elongated dimension as described herein, to provide overlay performance sensitivity suitable for an imprint lithography process, high accuracy overlay performance is limited in one-direction (e.g., sensitivity in x-direction, non-sensitivity in y-direction), and as such, template 18a may be used to pattern array field 60a of substrate 12. It should be noted and will be understood by one skilled in the art that control of overlay performance in a single direction (e.g., x-direction) with limited of no control of overlay performance in the other direction (e.g., y-direction) is contrary to accepted wisdom currently within the art. This method, however, provides adequate overlay performance with acceptable throughput for the unique shape and design of linear array template 18a.

Alignment system 112 may include a plurality of detection systems 114 and illumination sources 116. Each detection system 114 may include a detector 118 and illumination source 116. Each illumination source 116 may be coupled to impinge energy (e.g., light) upon a region of template 18a with which detectors 118 are in optical communication. For example, detection system 114 may be in optical communication with a region 120 of template 18a having alignment marks 110 disposed thereon. Illumination source 116 may provide optical energy to illuminate a region on template 18a. In one example, illumination source 116 may provide optical energy that impinges upon half-silvered (50/50) mirror and is directed along a path P to illuminate region. A portion of optical energy impinging upon region may return along path P and may be focused on detector 118.

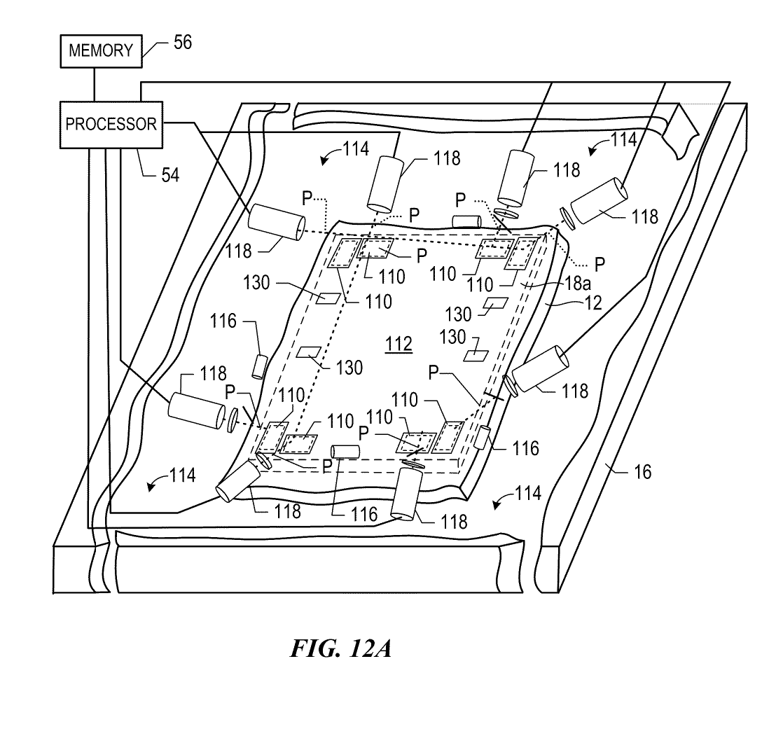

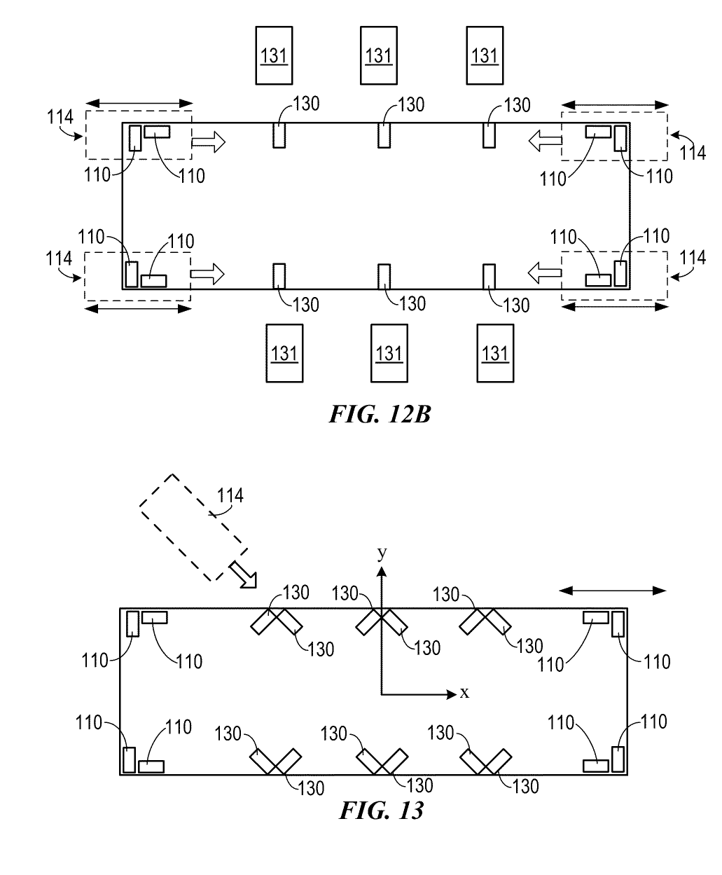

To ensure that the entire area of template 18a, and in particular mold 20, may be exposed to allow energy 40 to propagate therethrough, detectors 118, illumination sources 116, and other components of alignment system 112 may be positioned outside of the beam path of energy 40. FIGS. 12-13 illustrate exemplary embodiments of alignment system 112 having components outside of beam path of energy 40.

Referring to FIG. 12A, disposed at each corner of mold 20 is a set 122a-d of alignment marks 110. Each set 122a-d includes at least two alignment marks 110 positioned orthogonal to each other. For example, set 122a includes two alignment marks 110 with one alignment mark 110 positioned along the X-direction and one alignment mark 110 positioned along the Y-direction. This system is analogous to the alignment marks described in further detail in U.S. Ser. No. 11/000,331, which is hereby incorporated by reference in its entirety.

In addition to sets 122a-d, regional alignment marks 130 may be included along edges of template 18a and/or substrate 12. Alignment marks 110 and regional alignment marks 130 may be arrange to provide enough data for the direction of the higher overlay performance direction (e.g., x-direction vs. y-direction). Each detection system 114 provides a signal, in response to optical energy sensed. Signals may be received by processor in data communication therewith.

Alignment error detection system 114 generally may be positioned about template 18a and/or substrate 12. For the purposes of UV curing and whole field imaging, detection unit 114 may be positioned at a distance from the UV beam. For alignment marks 110 positioned at corners, detection system 114 (also shown in FIG. 12B) may be used. However, due to limited working distance of optical units, alignment data from regional alignment marks 130 may result in UV blockage. In one embodiment, each detection system 114 may be moveable such that detection unit may be repositioned to be in optical communication with regional alignment mark 130 to provide alignment data. For example, each detection system 114 may be capable of a scanning movement in an x and/or y-direction such that detection system 114 may provide alignment information at a first position and be repositioned at a second position at a distance from UV beam during imprinting.

It should be noted that additional optional detection systems 131 may be positioned at varying degrees along length of template 18 and/or substrate 12. For example, optional detection systems 131 may be positioned along x-axis providing alignment error for one or more alignment marks 130.

Referring to FIG. 13, in one embodiment, regional alignment marks 130 may be arranged (e.g., angled relative to the x-axis or y-axis) to provide alignment error. For example, regional alignment marks 130 may be positioned on or within template 18a and/or substrate 12 at an angle relative to the y-axis. Vector components in the y-direction may then be determined and used to provide data concerning spatial parameters of template 18a and substrate 12 and/or provide signals to minimize differences in spatial parameters. Alternatively, regional alignment marks 130 may be positioned on or within template 18a and/or substrate 12 at an angle relative to the x-axis and vector components in the x-direction may be determined. In one example, alignment marks 110 within sets 122 may also be angled relative to the y-axis.

Referring to FIG. 14, in order to support template 18a for lateral forces, forces F_{T} and F_{B} may be applied to template 18a. Application of F_{T} and F_{B} may be directed to elongated sides of template 18a. For example, force F_{T} a may be applied to template 18a by at least one force controllable actuator positioned at side 75 and F_{T} and F_{B} may be applied to template 18a by at least one force controllable actuator positioned at side 77. Actuator may be mechanical, hydraulic piezoelectric, electro-mechanical, linear motor, and/or the like. Actuators may be connected to surface of template 18a in such a way that a uniform force may be applied on the entire surface. Depending on the level of distortion control required, the number of independent actuators, or other similar systems, may be specified. Additionally, force controllable actuators may optionally be positioned at sides 71 and 73 providing F_{L} and F_{R} respectively. More actuators may provide greater control of distortion. Positioning of actuators, or other means of supplying force, however, may be limited to only two side of template 18a (elongated sides).

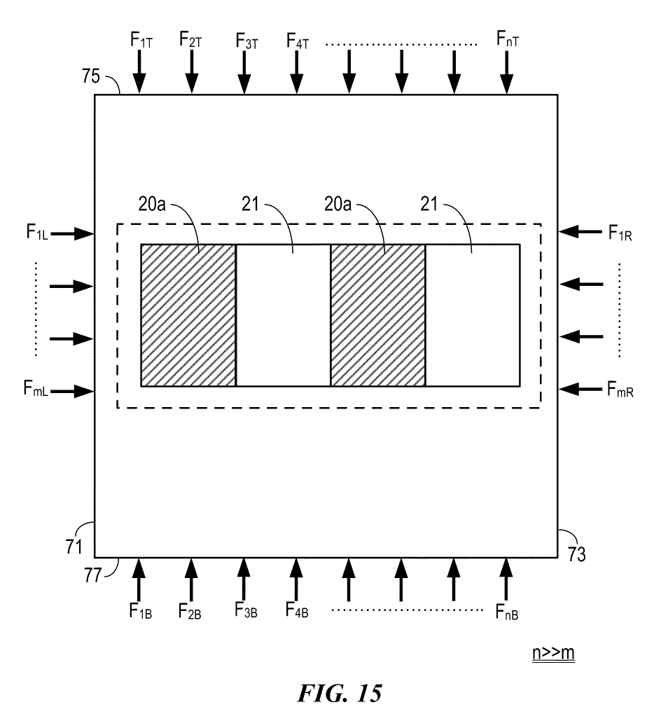

Referring to FIG. 15, in one embodiment, template 18a may include a plurality of mesas 20a separated by non-patterned areas 21. Application of forces may be directed to elongated sides 75 and 77 and/or non-elongated sides 71 and 73 of template 18a. Forces may be directed toward areas of mesas 20a disregarding distortion applied to non-patterned areas 21 to provide optimum imprinting conditions for mesas 20a of template 18.

Magnification and distortion compensation of template 18a and/or substrate 12 may also use systems and methods described in U.S. Ser. No. 09/907,512, U.S. Ser. No. 10/616,294, U.S. Ser. 10/999,898, U.S. Ser. No. 10/735,110, U.S. Ser. No. 11/143,076, U.S. Ser. No. 10/316,963, U.S. Ser. No. 11/142,839, U.S. Ser. No. 10/293,223, which are all hereby incorporated by reference in their entirety. Such systems and methods may be adjusted to provide correction along the elongated sides of template 18a.

What is claimed is:

1. A method, comprising:
aligning an imprint lithography template with a field on a substrate, the field of the substrate having a first side with a first dimension and a second side with a second dimension, the first dimension being substantially greater than the second dimension, wherein alignment sensitivity of the first side is substantially lower than the second side.

2. The method of claim 1, wherein the first dimension is at least twice the magnitude of the second dimension.

3. The method of claim 1, wherein the imprint lithography template includes a first side and a second side, the first side of the template having a mold positioned thereon and the second side of the template having a recess therein.

4. The method of claim 1, wherein the mold is elongated in a first dimension such that the mold is angled from a first corner edge of the template to a second corner edge of the template.

5. The method of claim 1, further comprising dispensing, by a dispense head, formable material on the field of the substrate, wherein the dispense head extends a length of the substrate.

6. The method of claim 1, further comprising providing energy to the field of the substrate in a beam, wherein shape of the beam is substantially similar to shape of the field.

7. The method of claim 1, further comprising imprinting the field of the substrate to form a relief pattern on the substrate.

8. The method of claim 7, wherein imprinting includes applying a first force to the imprint lithography template such that a portion of the template bows away from the substrate and a portion of the template bows towards the substrate.

9. The method of claim 8, wherein imprinting includes applying a second force to the substrate such that a portion of the substrate at a position orthogonal to the portion of the template bowing towards the substrate is bowed towards the template.

10. The method of claim 7 further comprising, separating the relief pattern from the template.

11. The method of claim 10, wherein separating includes applying a downward force to the template such a portion of the template bows away from the substrate and a center of the template bows towards the substrate.

12. The method of claim 1, wherein aligning of the imprint lithography template with the field on the substrate is provided by an alignment system, the alignment system having a plurality of detection systems and a plurality of illumination sources.

13. The method of claim 12, wherein the template includes at least one set of corner alignment marks.

14. The method of claim 13, wherein the template includes at least one regional alignment mark, wherein the regional alignment mark is positioned on the first dimension.

15. The method of claim 14, wherein at least one detection system is positionally movable to be in optical communication with the regional alignment mark.

16. The method of claim 15, wherein the regional alignment mark is positioned within the template at an angle relative to the y-axis.

16. The method of claim 1, further comprising applying a force by at least one force controllable actuator positioned at the first dimension of the template.

17. The method of claim 1, wherein aligning of the imprint lithography template with the field on the substrate is provided by an alignment system, the alignment system having a plurality of detection systems and a plurality of illumination sources wherein the detection systems are moveable along an entire side of the template.

18. The method of claim 17, further comprising stationary detection systems positioned about the first side of the template.

19. The method of claim 1, wherein the template includes a plurality of mesas and a plurality of non-patterning areas.
